(19) United States
(12) Patent Application Publication
(10) Pub. No.: US 2009/0045962 A1
(43) Pub. Date: Feb. 19, 2009

(54) CABLE OR BAND WITH A SEQUENCE OF RADIOFREQUENCY IDENTIFICATION INTEGRATED CIRCUITS (RFID) HAVING INDEPENDENT ANTENNA CIRCUIT AND USE OF THE RADIOFREQUENCY IDENTIFICATION IN INTEGRATED CIRCUITS

(76) Inventors: Sonia Deola, Falcade(BL) (IT); Mauro Scardanzan, Falcade(BL) (IT); Luca Nanetti, Groningen (NL)

Correspondence Address: GAUTHIER & CONNORS, LLP, 225 FRANKLIN STREET, SUITE 2300, BOSTON, MA, 02110, US

(21) Appl. No.: 12/145,010

(22) Filed: Jun. 24, 2008

Related U.S. Application Data
(63) Continuation of application No. PCT/IT2007/000015, filed on Jan. 9, 2007.

(30) Foreign Application Priority Data
Jan. 13, 2006 (IT) BL2006A000001
Feb. 22, 2006 (IT) BL2006A000008

(51) Int. Cl. G08B 13/14

(52) U.S. Cl. 340/572.7

(57) ABSTRACT

The invention relates to a filament or tape comprising a plurality of radio frequency identification integrated circuits (RFID), each one provided with independent antenna circuits, placed in sequence on a support.

### PRIORITY INFORMATION

The present application claims is a continuation of PCT/IT2007/000015 filed on Jan. 9, 2007 which claims benefit from Italian Patent Application Nos. BL2006A000001, filed on Jan. 13, 2006 and BL2006A000008, filed on Feb. 22, 2006, all of which are incorporated herein in their entirety.

### BACKGROUND OF THE INVENTION

The present invention relates to a filament or tape with a sequence of radio frequency identification integrated circuits (RFID) having independent antenna circuit.

The invention further relates to the use of single radio frequency identification integrated circuits, e.g. gauzes or tampons or textile items traceable with radio-frequency (RFID) identification technology.

It is known the need for foolproof identification of small objects in which it is impractical to incorporate or apply an RFID tag.

Current technology only consists of RFID tagging strips, which require precision cutting to avoid cutting into the antennae of the tag thereby making it unusable.

A radiofrequency device identifiable and callable without contact, capable to transmit at least an ID of sort is known, see e.g. U.S. Pat. No. 6,483,473B1, and U.S. Pat. No. 6,220,516 B1; a similar device with two antennas is known (WO 2005/093900A1). In this case, both antennas are planar and co-planar, leaving open the problem of spatial orientation (if the antenna is parallel to the magnetic field lines, the circuit is not activated, because no electrical current can be induced). A spatial, cubic-like 3-dimensional configuration of planar antennas is also known (US2005/0242959A1) that addresses this problem. However, the 3-d spatial configuration is doomed in itself to become immediately really bulky, making it impractical for a series of applications.

### SUMMARY OF THE INVENTION

The present invention has been made taking into account the above described problems. Specifically, the filament configuration with multiple antennas lying on different planes, as object of the present invention, is meant to overcome the above mentioned issues. The solution suggested according to the present invention permits solving the above mentioned problem, proposing the realisation of a filament or tape, comprising a plurality of radio frequency identification integrated circuits (RFID), each one having independent antenna circuit, placed in sequence on a support.

Further features of the filament or tape according to the invention are defined in the claims 19-20 and 25-32.

The invention further relates to gauzes or tampons or textile items that can be traced by radio-frequency (RFID) identification technology, characterised in that they provide a filament or tape as described in the above and claimed in the enclosed claims.

### BRIEF DESCRIPTION OF THE DRAWINGS

The present invention will be now described, for illustrative but not limitative purposes, according to its preferred embodiments, with particular reference to the Figures of the enclosed drawings, wherein:

FIG. 1 is a perspective view of a filament or tape according to the invention;

FIG. 2 is a schematic view of a filament or tape according to the invention;

FIG. 3 shows a particular of the filament or tape of the previous figures;

FIG. 4 shows and other particular of the filament or tape of the previous figures;

FIGS. 5a and 5b show schematic views of two further embodiments of the filament or tape according to the invention;

FIG. 6 shows a schematic view of a further embodiment of the filament or tape according to the invention;

FIG. 7 shows a schematic view of a further embodiment of the filament or tape according to the invention;

FIG. 8 schematically shows an application of the tape to a gauze or tampon ox textile;

FIG. 9 is a plan view of the application of FIG. 8;

FIG. 10 is a plan view of a gauze with RFID according to the invention; and

FIGS. 11a and 11b show two applications of a gauze according to the invention.

### DETAILED DESCRIPTION OF THE INVENTION

From now on the filament or tape will be referred to as one of more of the following terms: “filament”, “tape” and “antennae bearing filament” whilst still meaning the same object.

Observing the figures of the enclosed drawings, and particularly first FIG. 1, the solution according to the present invention provides a single long filament or tape 4, in which there are placed a series of RFID circuits 1 with independent antennae 5, 5′ which branch off from both sides of the said RFID circuits 1.

Usually, the antenna (single) has a single “inlet” point and a single “outlet” point from chip. In the present invention, n antennae, independent each other, exit from chip; this means that in case a cut deactivates some of them, e.g. “p”, n-p are still operative. This, generally speaking, can be realised in two ways (or by a combination of them):

a) chip must have n inlet points and n outlet points,

b) chip has an inlet point and an outlet point, and independence of single antennae branching from said points (this, indicated as “antenna circuit”, is ensured by the presence of suitable additional electronic components, such as, but not exclusively, diodes). This second case is that describing the situation indicated by “partially independent antennae”.

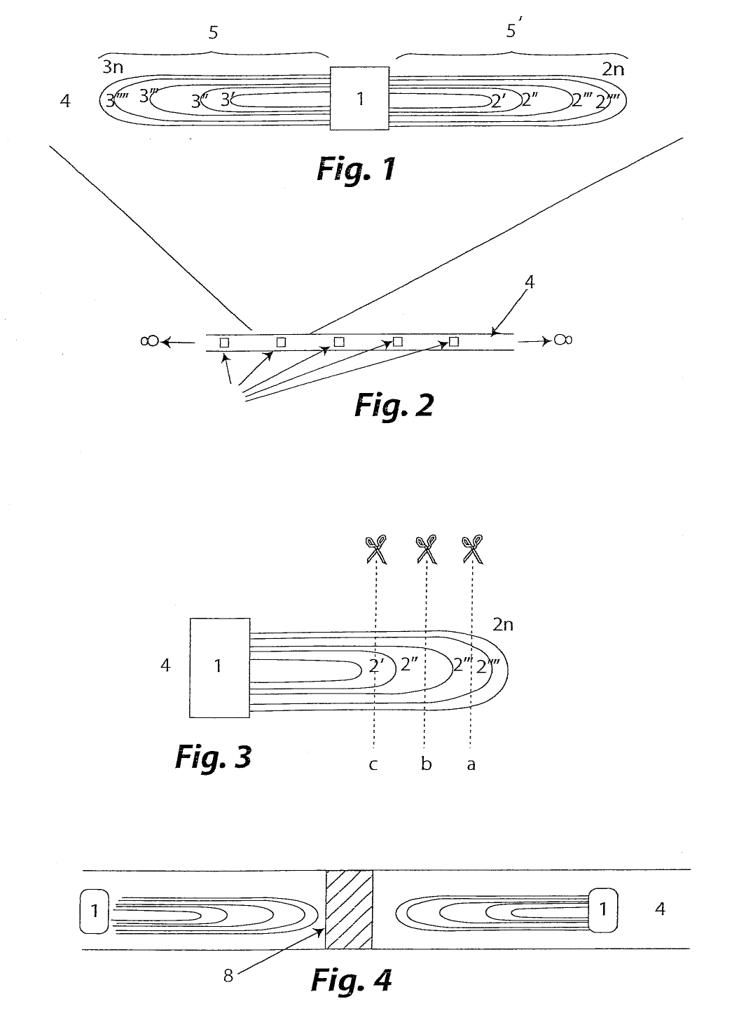

Another unique feature of the invention is that it is possible to cut the antenna filament 4 at practically any point between the two RFID circuits 1, and it is therefore possible to obtain an infinite number of RFID circuits equipped with as many antennae as remain intact after cutting. See particularly FIG. 3, wherein different antennae are indicated by reference numbers 2′, 2″, 2′″, 2″″, ecc., where only antennae 2 on one side of the RFID circuit 1 are shown.

The filament, or antennae bearing filament or tape 4, of indeterminate length, can be of any material in which it is possible to incorporate a series of objects as shown in FIG. 1, antennae 2—RFID circuit 1—antennae 2, antennae 2—RFID circuit 1—antennae 2 and so on indefinitely. Filament 4 can be made of fibre or of a homogenous material or a combination of part fibre and part homogeneous material with for example concentric layers of various substances.

The sections of antennae bearing filament 5, 5′, extending in both directions from the RFID circuit 1, support and/or protect more insulated antennae 2′, 2″, . . . , —3′, 3″, . . . , each of which constitutes a single independent antenna circuit.

The units consisting of a radio frequency circuit 1 equipped with two antennae 2, 3 on the two opposite ends, as shown in FIG. 2, follow one another along the entire length of the filament 4 and are an integral part of it.

In view of the lengthened and thin shape of the support, two general ways exist for realising the invention;
in first case, antennae are provided both on the left and on the right of the chip; even if cut destroys part of antennae on the right side, all antennae on the opposed side E are still intact; worse case being that providing a cut on the edge of the chip, so that all antennae on the right are inactive; but, in this case all left side antennae are intact.
in the second case, antennae are only on one side; a cut made in this zone clearly causes inactivation of some antennae (but not all of them). Surely, in this configuration, it is possible deactivating tag, if the cut were on the edge of the chip; this would involve the worse possible un-calibration of the cutting machine, also taking into consideration the possible presence of coloured markers or other solutions indicating the optimum cutting zone.

Another characteristic of this invention is that it is possible to obtain from one antenna filament 4, the desired number of “antenna-RFID circuit-antenna” units simply by cutting the filament 4 into sections at any point on the length of filament between two radio frequency circuits, as shown in FIG. 3, provided that the distance between the cutting is reasonably regular and on average equal to the distance between the two identity radio frequency circuits 1 mentioned above and the “antenna—RFID circuit—antenna” unit will still continue to function effectively since a certain number of isolated independent antennae will still remain unimpaired.

There will therefore always be a minimum area of antennae available for interaction with the external reader. If, just as an example, we imagine the three cutting areas a, b, c of FIG. 3, it is clear that if the antenna filament is cut in zone “a” the antennae 2′ 2″ 2′″ will remain unimpaired and fully functional and if cut in zone “b” the antennae 2′ 2″ will remain fully functional.

A cut very close to the radio frequency circuit in zone “c” will also maintain an unimpaired antenna; it should be noted that if the gap between cuts were reasonably regular the other side of the circuit would also have unimpaired antennae.

It should be noted in addition that it is also possible to obtain multiple numbers of the base units by cutting lengths that contain more than one RFID circuit 1 in order to have for example an extra margin of safety in identifying an object and or to join together the two ends of the length cut in order to form a ring.

To make the ideal cutting area on the filament 4 identifiable, this can be done for example, but not limited to, by one or more colours arranged in a certain pattern or in different sized blocks or in other different ways as shown in FIG. 4, in which the ideal cutting area 8 is represented by the area outlined.

The ideal cutting area 8 will be that area of the antenna filament 4 representing the only part of the antenna bearing filament 4 to be found in the gap between the two antennae 2, 3 belonging to two consecutive RFID 1 and can be used as a reference point for adjusting the phasing and width between cuts when it is placed in a production line.

Various other cutting areas can also be identified in a similar way.

The independence of the antennae can be obtained either physically or electronically, for example through the use of electronic devices such as diodes.

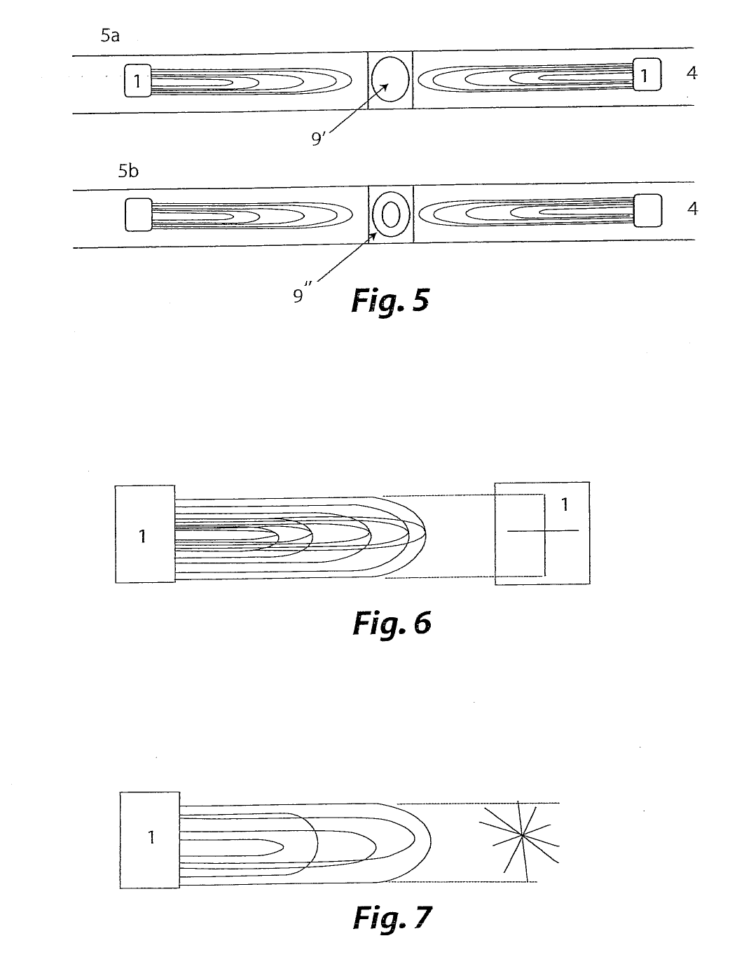

The filament 4 can include inert elements, as shown only as an example, in the area 8 of FIG. 4. Said inert elements are for example those shown in FIGS. 5a and 5b, where they are a sphere-shaped element 9′ and an oval eyelet 9″. These elements can be useful for attaching the filament section to an object that needs to have an RFID tag 1.

The independent antennae circuits are not limited to be placed only in one plane. In order to improve detection there could also be a second set of antennae placed at a particular angle (most likely but not necessarily at 90°) to the plane of the first set of antennae as shown in FIG. 6.

In addition each antenna circuit could be placed in a particular plane of its own, independently from other antennae circuit, as shown in FIG. 7.

It is surely true that, according to the invention, antennae must extend according to a horizontal direction, but:

a) distal part of antenna (i.e. the one farther from chip) can a square shape or a rounded shape, or it can be angled, or any combination,

b) proximal part of antenna (the one close to the chip) can have every shape, for example, coupling with chip can be oriented each other with a right or acute angle, they can be all equal or slightly different each other, thus determining slightly different shapes potentially for each single antenna.

c) “long” part of antenna must not necessarily be rectilinear, it can have slight undulations and/or angles without substantially loosing emission/receiving power (it should suffice thinking to TV antennae on the roof, under the wind, rain and hail action and still continuing working in an acceptable way). Similar deformation causes a different shape of the antenna.

d) orientation must be thought as the angle that the plane including antenna can have with respect to a reference plane, the axis being the same filament. Practically, under a geometrical point of view, it can be thought a beam of (potentially infinite) planes about an axis.

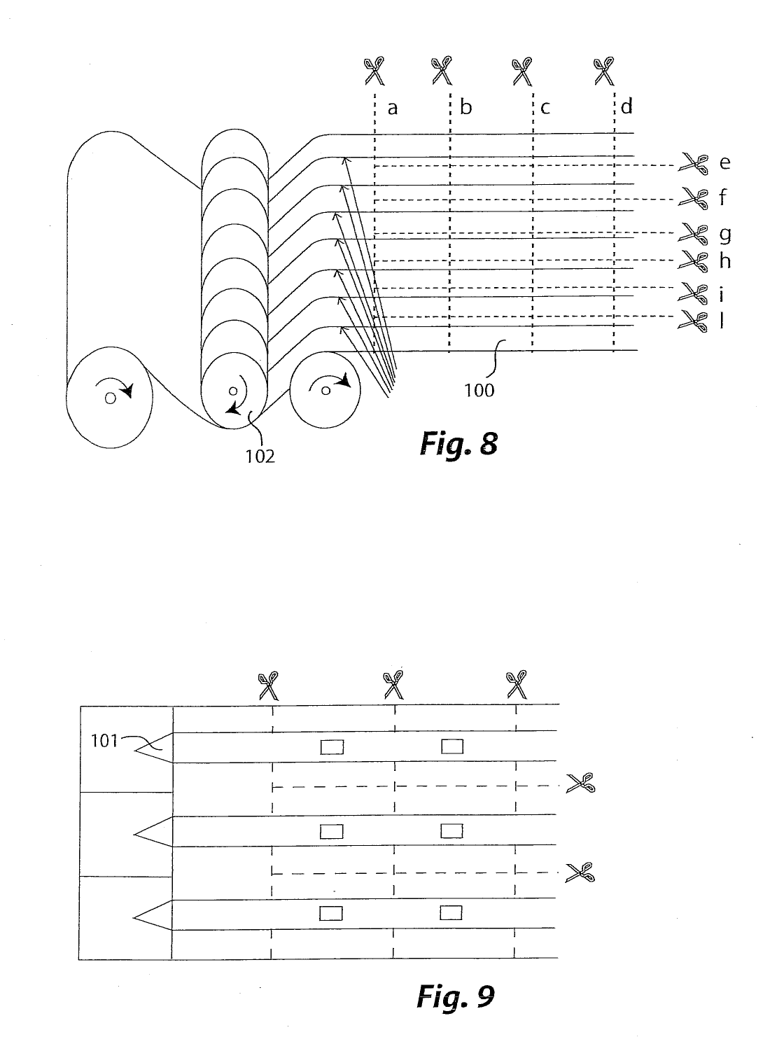

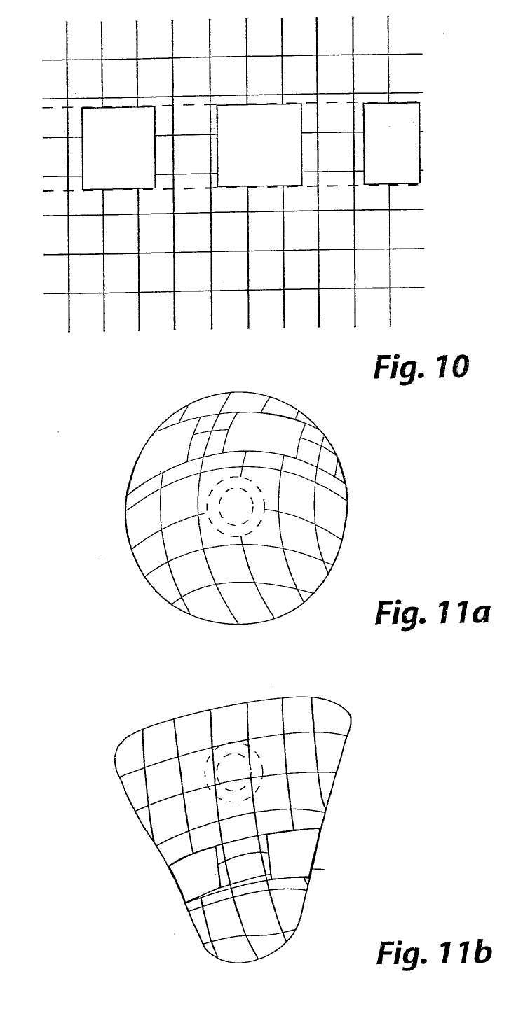

Coming now to observe FIGS. 8-11, it is shown a gauze or tampon or textile item, generically indicated by reference number 100, traceable and identifiable through radio frequency (RFID) technology as described with reference to FIGS. 1-7, for the purpose of avoiding the risk that one or more gauzes or tampons could be left inside the body of a patient, as well as for protection against counterfeit and stock management, particularly in the case of textiles.

At the moment it is possible to attach to a gauze, tampon or textile material radio frequency identifying devices (also known in English as “tags” or “transponders” or “transponditori” in Italian).

According to the present invention, optimum radio frequency integrated circuits for identification of gauzes, tampon or textile material are radio frequency identification integrated circuit with independent antenna circuits described in the above with reference to FIGS. 1-7.

Problems connected with the possibility that one or more gauzes or tampons could be left behind inside the body after an operation (statistically more likely in operations which are urgent or carried out on obese patients) are well known by the inventors and signatories of this application who have already made two industrial patent applications (BL2004A000024 and BL2004A000025, both dated 26.10.2004) aimed at providing a solution to the risk to the patient's safety arising from the current old fashioned procedure of manually counting gauzes where the human factor is of great significance. This solution to the problem contained in these two patents was to attach an active, passive or semi-active tag to all gauzes and tampons without identifying precisely the ideal integrated circuit: the purpose of the inventions was to make the process of counting the products automatic leaving a free choice of the type of tag to be applied to or placed in the items. Unfortunately the use radio frequency technology with these products has not been adopted and currently gauzes and tampons still have a barium thread woven into the fabric of the material: this blue thread is soft and identifiable with X-ray and checking the number of gauzes is still a manual process with the result that a product left behind will only be discovered through the use of invasive X-rays.

By the present invention it is suggested to equip gauzes and tampons not with any tag but with two specific, innovative and appropriate transponders capable of carrying out their particular function, that is communicating their presence remotely with a unique identity and without any physical contact.

RFID integrated circuits 1 according to FIGS. 1-7, besides being able to identify objects of reduced size, in which it is impractical to incorporate or apply traditional RFID tags, are in keeping with the production requirements of gauzes and tampons.

In order to explain application of RFID 1 more clearly, it is necessary to explain in theory how gauzes and tampons are produced:

A: the gauze is bought in rolls so that at the beginning there is one large and long roll of gauze wrapped around itself;

B: the gauze is rolled out and at the same time and at suitable intervals, according to the end product being made, the blue barium thread identifiable through X-ray is woven in;

C: at this point, the large roll of gauze with many barium woven into it is cut in order to obtain the smaller small pieces of fabric which can vary in size (the smallest measures 4×4 cm) each containing a barium thread;

D: the gauze pieces of fabric and barium threads are then folded in the required way to obtain gauzes or large or small tampons or laparotomic gauzes;

E: the folding of the gauzes takes place at the final stage because, with a prick punch or similar device there is inserted into the gauze piece of fabric a circular elastic of around 5 mm in diameter and at the same time the gauze piece of fabric with the barium thread is wrapped with elastic which remains inside the tampon fixing it firmly so that it cannot change its spherical shape. Of course, for commercial reasons, the shape of the tampons can vary but all have the elastic inside (solely as examples the size of the tampons can vary from 4×4 cm in a non-circular shape (see FIG. 11b) to 6 mm in diameter for those with a circular shape (see FIG. 11a): the latter type of semi rigid tampon is much more difficult to detect by X-ray because of small size.

In any case, even if the productions stages are not always precisely as described the barium thread is woven into all the gauze pieces of fabric and all the tampons (whether big or small but made from a piece of gauze) are kept in shape by the elastic, which remains inside the tampons.

Particularly with regard to the use of barium thread and elastic the inventors have devised ideal radio frequency integrated circuits which can be used for the identification of gauzes, tampons and textile fabric in general, with independent antenna circuits and a radio frequency identification integrated circuit with extensible antenna: the first is applicable to all gauzes and types of fabrics (such as barium thread either in conjunction with or as replacement of).

In summary, the radio frequency identification integrated circuit with independent antenna circuits, described with reference to FIGS. 1-7, is a filament or strip 4 consisting of a series of radio frequency identification integrated circuits 1 with more independent antenna circuits 2, 3: in this way, the filament 4 with independent circuits can be inserted or threaded or adhered or in some way attached inside the weave of a fabric (FIG. 9) so that it can then be cut with it into the gauze or fabric in the smallest required shape (FIG. 8, particulars a, b, c, d, e, f, g, h, i, l).

Free cutting does not jeopardize the working of the integrated circuit because the independent antenna circuits can be cut and there will always be one or more circuits that are closed and therefore working. Using filament 4 as described it will not be necessary to change the supposed sequence of production (FIGS. 8 and 9): simply instead of, or in addition to the barium thread the new filament 4 detectable through radio frequency can be used (FIGS. 8, 9, 10).

Of course, according to the present invention, it is possible to have more reels of RFID filament 4 with RFID tags 1 at suitable distances (FIGS. 8 and 9) so that each piece of gauze fabric has a tag.

Of course, in the supposed production phase according to this invention the roll or rolls of integrated circuit 1 filament or tape 4 with radio frequency identification with independent antenna circuits 2, 3 have to go in the opposite direction to the rolling out of the large gauze 100 in order for it to be possible to insert the filament or tape into weave of the gauze 100 itself. The insertion can be carried out with a type of needle or similar device 101 which is threaded with the filament 4 with independent antenna circuits 2, 3: the running out of the gauze 100 from another roll 102 makes it possible to insert the filament 4 in the weave of the gauze. The needle 102 can also carry out movements in any direction in order to insert the filament into the fabric so that is solid with it. Manual, automatic or semiautomatic cutting of the gauze will not jeopardize the functioning of the antenna circuits because they are independent and there are several of them.

Manual, automatic or semiautomatic cutting of the gauze will not jeopardize the functioning of the antenna circuits 2, 3 because they are independent and there are several of them.

It is quite evident that the use of integrated circuits 1 can be extended, beyond gauzes and tampons, to all textile products which are able to incorporate, receive or incorporate a filament or tape 4 with radio frequency identification integrated circuits 1 with and of course for products requiring elastic that are able to incorporate or support a radio frequency identification circuit with extensible antenna 2, 3.

Identification integrated circuit system with independent extensible antenna circuits can be used in the following cases:

at the end of an operation, an employee, using a portable device, checks the presence of gauzes and tampons inside the body of the patient by passing this device over the patient before stitching;

similarly, using the same device or one similar, an operator checks the number of gauzes and tampons thrown away by passing the same device over the container used for collecting the discarded material;

similarly, using the same device or one similar, an operator checks the number of gauzes and tampons put aside for use but not actually used passing the device over the container which has collected the material to be used;

after the operation the patient has the above-mentioned gate passed over them;

similarly, using the same gate or one similar, passing the container that has collected the rejected material across the gate checks the number of gauzes or tampons used and thrown away;

similarly, using the same gate or a similar device, the number of gauzes and tampons put aside for use but not actually used is checked passing the container which has collected the material set aside to be used over the gate.

The present invention has been described for illustrative but not limitative purposes, according to its preferred embodiments, but it is to be understood that modifications and/or changes can be introduced by those skilled in the art without departing from the relevant scope as defined in the enclosed claims.

What is claimed:

1. Filament or tape comprising: a sequence of one or more radio frequency identification integrated circuits (RFID tags), wherein each circuit has multiple antennas, lying on different planes whenever the geometry of the allows it (filament).

2-18. (canceled)

19. Filament or tape according to claim 1, wherein it has various degrees of elasticity either in parts or throughout its length.

20. Filament or tape according to claim 1, wherein it has various degrees of flexibility either in parts or throughout its length.

21-24. (canceled)

25. Gauzes or tampons or textile material that can be detected by radio frequency identification (RFID) technology means, wherein they provide one filament or tape according to claim 1.

26. Filament or tape comprising one or more tag circuits according to claim 1, where each antenna can have a different length.

27. Filament or tape comprising one or more tag circuits according to claim 1, where the multiple antennas can have common connection points with the integrated circuit.

28. Filament or tape comprising one or more tag circuits according to claim 1, where the independency of antennas is ensured by the presence of additional electronic circuits, for instance, but not limited to, using diods.

29. Filament or tape comprising one or more tag circuits according to claim 1, where in the case of antennas lying on different planes the angle between planes can be constant or variable.

30. Filament or tape comprising one or more tag circuits according to claim 1, where the integrated circuit can be physically detached from the antenna.

31. Filament comprising one or more tag circuits according to any of the previous claims, where the filament holding the antennas lying on different planes can be made by concentric layers.

32. Filament comprising one or more tag circuits according to claim 1, where the filament holding the antennas lying on different planes can be made folding or rolling one or more layers of any material.
